(19) United States
(12) Patent Application Publication
(10) Pub. No.: US 2006/0070008 A1
(43) Pub. Date: Mar. 30, 2006

(54) Preserving browser window integrity

(75) Inventors: Aaron J. Sauve, Seattle, WA (US); Ann M. Seltzer, Bellingham, WA (US); Robert S. Dirickson, Issaquah, WA (US); Roberto A. Franco, Seattle, WA (US); Jeff Davis, Redmond, WA (US); Roland Tokumi, Issaquah, WA (US); John Bedworth, Redmond, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 10/954,702

(22) Filed: Sep. 29, 2004

(51) Int. Cl. G06F 3/00

(52) U.S. Cl. 715/788; 715/806; 715/808

(57) ABSTRACT

A method and system for preservation of browser window integrity is disclosed. The position and size of script-created windows is adjusted as necessary to preserve critical data on the computer screen prior to rendering those windows. Popup windows are similarly adjusted so that window integrity is preserved. Popup window size is adjusted to be smaller than the vertical size of the popup's parent window. Popup window position is modified so that popups do not extend above the top, or below the bottom, of their parent window. Finally, the popup position in the z dimension is adjusted so that the popup appears immediately above its parent window.

### TECHNICAL FIELD

The present invention relates generally to the field of content browsers. More particularly, the present invention relates to displaying data via an application executed on a computer. More particularly still, the present invention relates to restricting the size and position of content browser windows to preserve integrity.

### BACKGROUND OF THE INVENTION

A content browser (hereafter, “browser”) is an application used to locate and display web pages, or other content. A browser application retrieves web content elements (such as images, controls, text, etc.) and renders them in one or more user interface (UI) windows. The UI refers to what is displayed, or otherwise presented, to the user by the application through a display device or other output device.

A script is a list of commands that can be executed without user interaction. For example, a web page can include one or more scripts which can range in complexity from changing an image, to creating a new window, to entire online applications. Such scripts can be written in Java, perl, or other interpreted or compilable script language known to those skilled in the art, or in a combination thereof.

A window is a division of a computer display screen which has boundaries, and is usually a rectangular area. In a graphical user interface (GUI), windows can be typically be opened, closed, and moved around on the screen. The user can typically control the size and shape of the windows. Windows can overlap other windows partially or fully.

A popup window (hereafter, “popup”) is a type of window that appears on top of (over) the browser window, and is usually triggered by a script which is triggered by the content being browsed. Popups can be somewhat obtrusive, in that they often cover other windows, particularly the browser window that the user was in the process of reading. Popup ads are used extensively in advertising on the Web, though popups have other applications as well. Popups typically lack the normal controls associated with a browser window, such as a title bar, status bar, scrollbar, navigation controls, etc.

A parent window is the primary window of the application that launched the window. In the context of browsers, the parent window describes the portion of the browser window that contains the content being browsed, but generally does not include the title bar, status bar, navigation controls, scrollbar, address bar, or other non-content-controlled portions of the browser window.

Windows typically occupy a desktop, which is an on-screen work area that uses icons and menus to simulate the top of a desk.

One problem with existing windows is that script-created windows could be maliciously drawn to extend beyond the size of the display screen, and then cover important elements of the window. Moreover, such windows could also be made to appear to be operating system dialog windows, or even mimic the entire desktop. Further, these windows could also be used to fool the user into thinking that a trusted web site is currently being browsed. Such confusion could lead to even bigger problems if the user is tricked into giving confidential information to an untrusted site.

It is with respect to these considerations and others that the present invention has been made.

### SUMMARY OF THE INVENTION

In accordance with the present invention, a computer-implemented method is provided for the preservation of browser window integrity. A position for a proposed script-created window is received. A size for the proposed window is also received. The position is adjusted as necessary to preserve critical data on the computer screen. The size is likewise adjusted as necessary to preserve critical data on the computer screen. Finally, the proposed window is drawn at the adjusted window position with the adjusted window size.

In accordance with other aspects, the present invention relates to a system for the preservation of browser window integrity. A receiving module receives window position and window size for a script-created window. A position adjustment module adjusts the position of the window as necessary to preserve browser window integrity. Likewise, a size adjustment module adjusts the size of the window as necessary to preserve browser window integrity. Finally, a display module displays the window at the adjusted position, and of the adjusted size.

In accordance with yet other aspects, the present invention relates to a method for popup sizing and placement wherein window integrity is preserved. First, the size of the popup is reduced such that the popup size is less than the vertical size of the popup's parent window.

Next, the popup position is adjusted so that the popup does not extend above the top of the popup's parent window. Next, the popup position is adjusted so that it does not extend below the bottom of the popup's parent window. The popup position is then adjusted so that the popup appears immediately above its parent window.

The invention may be implemented as a computer process, a computing system or as an article of manufacture such as a computer program product or computer readable media. The computer readable media may be a computer storage media readable by a computer system and encoding a computer program of instructions for executing a computer process. The computer program readable media may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 shows a computer networking environment implementing one embodiment of the present invention.

FIG. 2 illustrates an example of a suitable computing system environment on which an embodiment of the present invention may be implemented.

FIG. 3 illustrates the operational flow of the operations performed in one embodiment of the present invention.

FIG. 4 illustrates the operational flow of the operations performed in another embodiment of the present invention.

FIG. 5 illustrates an example screenshot where, without the use of the present invention, a popup can be used to mislead the user.

FIG. 6 illustrates an example screenshot where, using an embodiment of the present invention, the effects of the misleading popup shown in FIG. 5 are mitigated.

FIG. 7 illustrates another example screenshot where, without the use of the present invention, a popup can be used to mislead the user.

FIG. 8 illustrates an example screenshot where, using an embodiment of the present invention, some aspects of the misleading popup shown in FIG. 7 are mitigated.

FIG. 9 illustrates an example screenshot where, using an embodiment of the present invention, other aspects of the popup shown in FIG. 7 are mitigated.

### DETAILED DESCRIPTION OF THE INVENTION

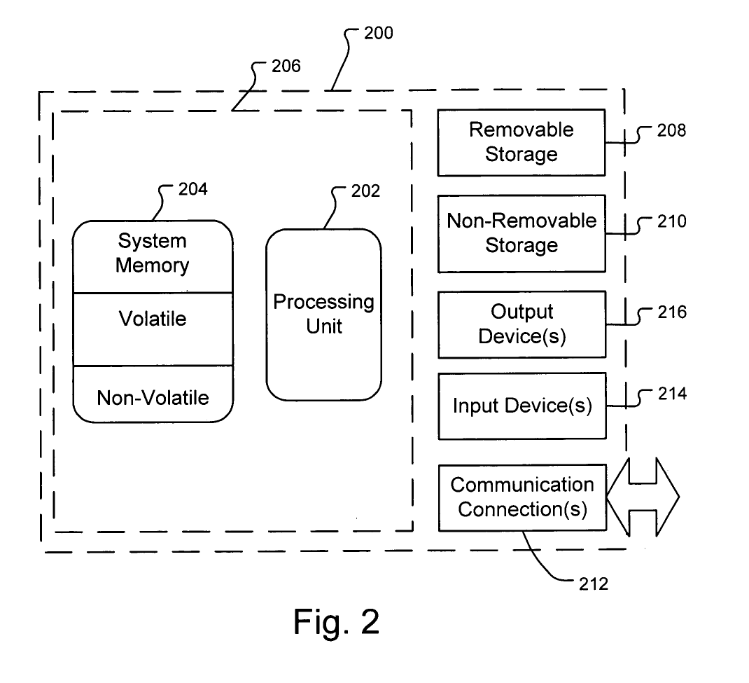

The embodiments of the invention described herein may be implemented as logical operations in a distributed processing system or network 100 having a client computer system 102 and, optionally, a network server computer system 104, as shown in FIG. 2. The logical operations of the present invention are implemented (1) as a sequence of computer implemented steps running locally on the computing system 102 and/or (2) as interconnected machine modules within the computing network 100. Accordingly, the logical operations executed by the browser portion of the operating system of the present invention as described herein are referred to alternatively as operations, acts, or modules. It will be recognized by one skilled in the art that these operations, acts and modules may be implemented in software, in firmware, in special purpose digital logic, and any combination thereof without deviating from the spirit and scope of the present invention as recited within the claims attached hereto.

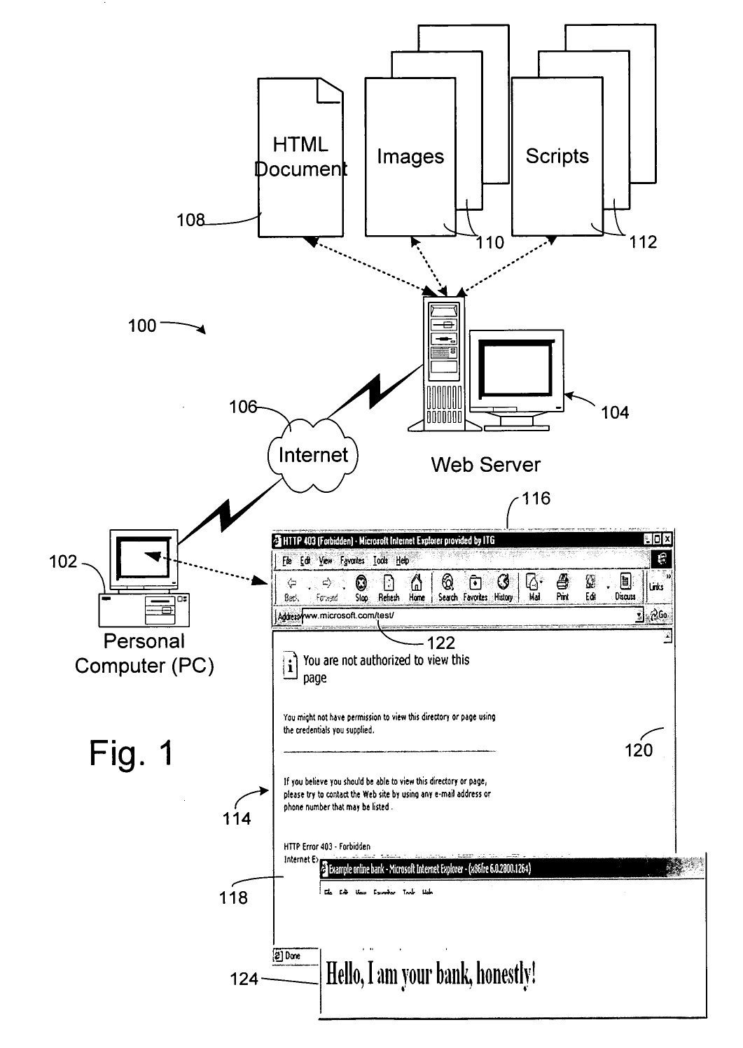

In the client-server environment 100 of an illustrated embodiment of the invention shown in FIG. 1, the client computer system 102 runs a browser module (hereinafter browser) as part of the operating system on the computer 102 for retrieving or browsing electronic documents from a remote server computer 104. The illustrated remote computer network 106 is the Internet. In the illustrated client-server environment 100 the client computer system 102 connects to the computer network 106 over a telephone line with a modem (not shown) or other physical connections alternatively can be used such as a network interface, an ISD1, T1 or the like high speed telephone line, a television cable, a satellite link, an optical fiber network, an Ethernet or local area network technology wire and adapter card, radio or optical transmission devices, etc. The invention can alternatively be embodied in a client-server environment for other public or private computer networks, such as computer network of a commercial on line service or an internal corporate local area network (LAN) or like computer networks. Alternatively, the invention can be embodied entirely on the client machine when browsing content kept on the client. In this case, electronic document 108 (described below) and scripts 110 (described below) would exist on a storage medium local to the client. An electronic document 108 resides at a remote computer 104 also referred to as a web server connected to the computer network 106. The illustrated electronic document 108 conforms with HTML standards, and may include extensions and enhancements of HTML standards. In conformance with HTML the electronic document 108 can incorporate other additional information content 110 and 112, such as audio video executable programs, images, etc., hereafter simply images 110, and executable scripts, hereafter simply scripts 112, which also reside at the remote computer 104. The electronic document 108, images 110 and scripts 112 may be stored as files in a file system of the remote computer 104. The electronic document 108 may incorporate the images 110 and scripts 112 using HTML tags that specify the location of files containing the executable instructions on the Internet 106. In alternative network protocol embodiments of the invention the electronic document 108 can have other structured document formats.

The browser on the computer 102 retrieves an electronic document 108 from its site, i.e., the web server 104 on the Internet 106, and displays the document on the computer screen or output device 216 (FIG. 2). To view the document 108, the user specifies a URL related to the particular document 108, such as by entering a URL character string with a keyboard, by selecting a hyperlink specifying the URL in an HTML document currently being displayed in the browser display 114, or by selecting a URL from a list provided by the browser. In response to the entered URL the browser generates a request command for the URL and transmits the request on the Internet 106 for the document 108 and the respective images 110 and scripts 112 related to the document 108 using conventional Internet protocols, e.g., the Hypertext Transport Protocol (HTTP).

In one embodiment of the present invention, the browser utilizes a graphical interface, generating the rectangular viewing or display area 114 on the screen of the computer's output device 216 (FIG. 2) as is conventional in an operating system with a graphical user interface. The browser includes a window 116 with graphical interface user controls (e.g. menu bar, scroll bars, buttons, etc.) which generally surrounds a document area 118 in the display 114. The user interface controls for the frame 116 can be activated by the user with the input device 214 (FIG. 2) to control the browser.

The browser displays the electronic document 108 that the user is currently viewing in the document display area 118. If the electronic document is too large to completely fit within the document area 118 the browser displays a portion of the document in the document area 118 and presents a scroll bar 120 in the browser frame 116. The user can manipulate the scroll bar 120 with a mouse or other pointing device or input key commands on the keyboard to change the visible portion of the document that is shown by the browser within the document display area 118. Manipulating the scroll bar 120 generally does not change the size or position of the window. The display 114 also comprises an address bar 122. The address bar displays the URL for the document 108 currently being displayed in document area 118. A popup 124 appears on top of the frame 116. Popup 124 does not cover up the address bar 122, or any of the contents of the document area 118. However, it could just as readily cover strategic portions of the frame 116 to mislead the user as to the contents of frame 116.

Given that the present invention may be implemented as a computer system, FIG. 2 is provided to illustrate an example of a suitable computing system environment on which embodiments of the invention may be implemented. In its most basic configuration, system 200 includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206.

In addition to the memory 204, the system may include at least one other form of computer-readable media. Computer-readable media can be any available media that can be accessed by the system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Memory 204, removable storage 208, and non-removable storage 210 are all examples of computer storage media.

Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain a communications connection(s) 212 that allow the system to communicate with other devices. The communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In accordance with an embodiment, the system 200 includes peripheral devices, such as input device(s) 214 and/or output device(s) 216. Exemplary input devices 214 include, without limitation, keyboards, computer mice, pens, or styluses, voice input devices, tactile input devices and the like. Exemplary output device(s) 216 include, without limitation, devices such as displays, speakers, and printers. For the purposes of this invention, the display is a primary output device. Each of these devices is well know in the art and, therefore, not described in detail herein.

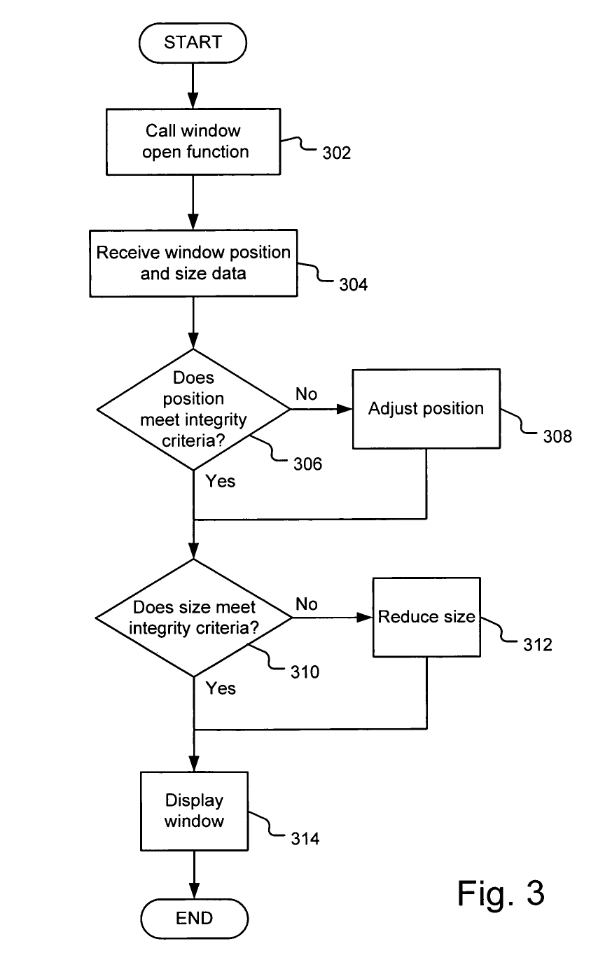

FIG. 3 illustrates one embodiment of the invention in which a script-generated window is restricted. In one embodiment of the present invention, call operation 302 calls a window open function via a window creation command within a script. In an alternate embodiment, call operation 302 calls a window open method, which is a special kind of function closely associated with a window object known to those skilled in the art. In particular embodiments, call operation 302 is performed by the browser in response to the window creation command in the script. The script may be initiated by content being browsed, and in response, operations (such as call operation 302) are performed by the browser application. If a method is called by call operation 302, the parent window information is implicitly available when later determining whether integrity criteria have been met (discussed below). If a non-method function is called by call operation 302, parent window information may be explicitly sent with the call, or default information may be used.

Receive operation 304 receives the position and size data for the proposed window. The position and size data may be expressed in pixels, inches, centimeters, millimeters, points, or similar discrete or non-discrete measurement units, or relative percentages thereof. Position may be expressed relative to a home position (for example, the bottom left of the screen or window). In one particular embodiment, receive operation 304 relates to a browser application receiving such size and location information from a particular script or second application requesting to display a window.

Upon receiving position information, and prior to actually opening or displaying the window, determine operation 306 determines whether the proposed position meets criteria for window integrity. In one embodiment of the present invention, determine operation 306 determines whether the window, including its title and status bars, is completely within the viewing area of the desktop region of the screen. Data regarding the dimensions of the viewing area of the desktop region may be queried via a graphical user interface service, read from a desktop configuration file, or other method known to those skilled in the art. If the proposed position meets the aforementioned criteria, more specifically that the window is completely within the viewing area of the desktop region of the screen, flow branches YES to determine operation 310, discussed below. Otherwise, if the proposed position does not allow the window to fit within the desktop region, flow branches NO to adjust operation 308.

Adjust operation 308 adjusts the position of the window according to the criteria for window integrity used by determine operation 306. In one embodiment, this may include shifting the window up, down, left or right, but not changing the size of the window. In a particular embodiment of the present invention, these criteria are the same as those used in determine operation 306, e.g., that the window, including its title and status bars, is completely within the viewing area of the desktop region of the screen. In alternative embodiments, other sets of criteria may be used by adjust operation 308. For example, a more limited set of criteria could be used to simultaneously enforce additional window placement goals related to, or unrelated to window integrity.

Following adjust operation 308, or in cases where determine operation 306 determines that the size criteria matches or falls within the predetermined position threshold values, determine operation 310 determines whether the proposed size meets criteria for window integrity. In one embodiment of the present invention, determine operation 310 determines whether the window, including its title and status bars, is completely within the viewing area of desktop region of the screen. If the proposed size meets the predetermined size criteria, flow branches YES to display operation 314. Otherwise, if the proposed size fails to meet or fall within the predetermined size values, flow branches NO to reduce operation 312.

Upon determining that the proposed size does not satisfy pretermined requirements, reduce operation 312 reduces the size of the window according to criteria for window integrity. In one embodiment, reduce operation may shrink the window lengthwise and/or heightwise, without modifying the position of the window. In a particular embodiment of the present invention, these criteria are the same as those used in determine operation 310, e.g., that the window, including its title and status bars, is completely within the viewing area of the desktop region of the screen. In alternate embodiments, other sets of criteria may be used by reduce operation 312. For example, a more limited set of criteria could be used to simultaneously enforce additional window placement goals related to, or unrelated to window integrity.

Finally, display operation 314 displays the proposed window. This operation typically includes drawing, or “rendering,” the window. In one embodiment of the present invention, display operation 314 relies on the browser application to render the window. In another embodiment, display operation 314 relies on operating system calls to render the render the window. In still another embodiment, display operation 314 relies on a set of graphical user interface services. For example, the browser application could make one or more calls to an application program interface (API), which is a set of routines, protocols, and tools that software applications can use to interface with an operating system or window manager.

One skilled in the art will appreciate that determine operation 306, and determine operation 310 could take place in the opposite order without departing from the scope of this invention. In an alternative embodiment, determine operation 306 and determine operation 310 could be combined into a single step. In a further alternative embodiment, position and size integrity criteria could be used to predetermine an acceptable area for window placement, and a single determine operation (not pictured) would choose a subset of that acceptable area into which the proposed window would be placed.

By ensuring that the proposed window is rendered completely within the viewable area of the desktop, malicious sites are prevented from spoofing an entire desktop. Prior to the claimed invention, a script could create a window with its controls, scrollbar, title bar, etc. off the screen (and thus not visible to the user), with the visible window content resembling a desktop. Users could then be fooled into selecting a potentially harmful control within the window content, thinking it was actually one of the icons or controls on their desktop.

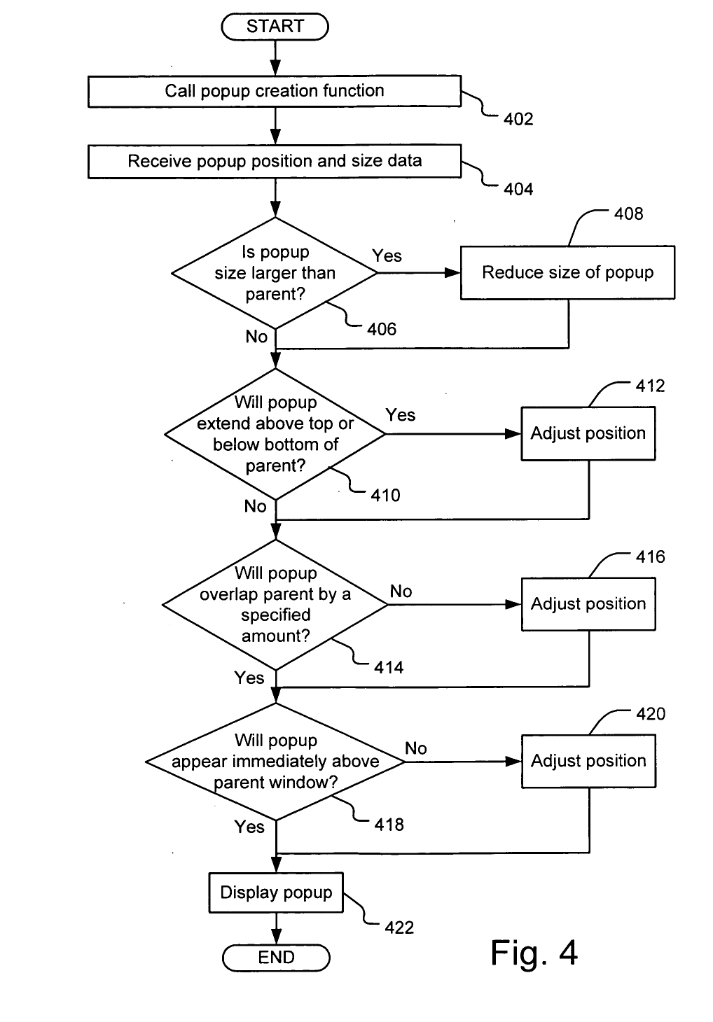

FIG. 4 illustrates an embodiment of the invention in which a script-generated popup is restricted. Scripts that generate popups are increasingly common on the web today, and are often associated with or embedded in the web content being browsed. In one embodiment of the present invention, call operation 402 calls the popup creation function via a popup creation command within a script. In an alternate embodiment, call operation 402 calls a popup creation method, which is a special kind of function closely associated with a popup object known to those skilled in the art. If a method is used, the parent window information is implicitly available when later determining whether integrity criteria have been met (discussed below). If not, parent window information must be explicitly included or sent with the call, or default values must be used.

Upon calling the popup creation function, receive operation 404 receives the position and size data for the proposed popup from call operation 402. The position and size data can be expressed by the script author in pixels, inches, centimeters, millimeters, points, or similar discrete or non-discrete measurement units, or relative percentages thereof. Position may be expressed relative to a home position (for example, the bottom left of the screen or window). The browser or its associated GUI services handle any unit conversion or relative computations that may be necessary.

Upon receiving the position and size information, determine operation 406 determines whether the size of the proposed popup is greater than the vertical size of the parent window. If it is not, then flow branches NO to determine operation 410. If the size of the proposed popup is greater than the vertical size of the parent window, then flow branches YES to reduce operation 408. Reduce operation 408 then reduces the size of the proposed popup so that it is less than or equal to the size of the parent window.

In some cases, reduce operation 408 reduces the vertical dimensions of the popup, while in other cases, reduce operation 408 reduces the horizontal dimensions of the popup. Of course, reduce operation 408 may also reduce both horizontal and vertical dimensions of the popup.

Following reduce operation 408 (or determine operation 406, in cases where no reduction is necessary), determine operation 410 determines whether the proposed popup will extend above the top, or below the bottom, of the parent window. If neither is true, flow branches NO to determine operation 414, discussed below. If either or both are true, flow branches YES to adjust operation 412.

Adjust operation 412 adjusts the position of the proposed popup so that it neither extends above the top of the parent window, nor extends below the bottom of the parent window. In an alternative embodiment of the present invention, adjust operation 412 also adjusts the size of the proposed popup. In another alternative embodiment, adjust operation 412 adjusts the size, but not the position, of the proposed popup.

Determine operation 414 determines whether the proposed popup will overlap the parent window by a specified amount. The existence of overlap serves to help the user associate the popup and the parent window. If the windows were instead disjointed, and the popup looked like an operating system dialog box, the user could easily be tricked into selecting a control within the popup that may have undesirable consequences. Therefore, overlap control and positioning helps provide continuity between the parent and the popup.

In one embodiment of the present invention, the described specified amount of overlap is specified by a browser application developer. In another embodiment, the specified amount is determined dynamically as a percentage of total screen size. In yet other embodiments, users may have some control over this feature. Those skilled in the art will appreciate that other static and dynamic specification methods can be used without departing from the scope of the claimed invention If the specified overlap will occur, flow branches YES to determine operation 418. However, if said overlap will not occur, flow branches NO to adjust operation 416.

Adjust operation 416 adjusts the position of the proposed popup so that it overlaps the parent window by a specified amount. Again, this specified amount can be set statically or dynamically, and need not be the exact same amount as used by determine operation 416. In an alternative embodiment of the present invention, adjust operation 416 also adjusts the size of the proposed popup to establish sufficient overlap with the parent window. In another alternative embodiment, adjust operation 416 adjusts the size, but not the position, of the proposed popup to establish overlap and thus congruency.

Following adjust operation 416 (or determine operation 414 in cases where such adjustment was not necessary) determine operation 418 determines whether the proposed popup appears substantially immediately above the parent window. In this case, substantially immediately above means that no other windows will appear between the parent window and the popup when the latter is created. The popup will stack on top of the browser window, with no interposing windows of any kind. This requirement prevents the popup from masking over a dialog box that is attempting to warn the user about a potentially unsafe operation that the browsed page is attempting to initiate, or a portion of that dialog box.

If the proposed popup will appear immediately above the parent window, flow branches YES to display operation 422. However, if the proposed popup will not appear immediately above the parent window, flow branches NO to adjust operation 420.

Adjust operation 420 adjusts the position of the proposed popup so that it appears immediately above the parent window. One way it can do this is by altering the proposed popup's position in the stack of windows on the user's screen. This position is often referred to as the “z coordinate” of a window.

One skilled in the art will appreciate that determine operations 406, 410, 414, and 418 could occur in other orders than the example presented herein, without departing from the scope of this invention. Further, in an alternative embodiment, two or more of determine operations 406, 410, 414, and 418 could be combined into a single step. In a further alternative embodiment, position and size integrity criteria could be used to predetermine an acceptable area for window placement according to the criteria given for each determine operation, and a single determine operation (not pictured) would choose a subset of that area into which the proposed window would be placed.

Display operation 422 renders the proposed popup on the screen. As described above, the size and position are determined by the position and size data received by receive operation 404, and by reduce operation 408 and adjust operations 412, 416, and 420, if they occurred. The window may be rendered or drawn on the screen by way of an application program interface (API) call, or other methods known to those skilled in the art.

The described operations prevent popup windows from spoofing web browser controls, desktop controls, and dialog boxes. Prior to the claimed invention, a popup window shaped and sized the same as a browser address bar could be used to obscure the true address of content being browsed. The user could thus be fooled into thinking they are accessing a trusted site, and divulging confidential information such as account numbers and passwords.

In another embodiment of the present invention, popups are forced to include a status bar to provide the user with further clarification regarding their nature. Using this restriction, window integrity is further protected, since a popup with a status bar cannot convincingly spoof several kinds of controls, such as browser address bar contents or a desktop icon. In such a case, the added status bar “baggage” would stand out, and destroy the illusion that the malicious script author seeks to create.

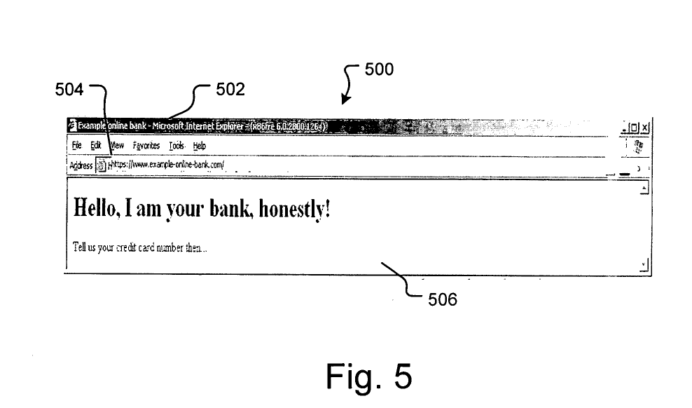

FIG. 5 illustrates an example screenshot 500 where, without the use of the present invention, a popup 504 might mislead the user as to which site is being viewed. In this case, the popup 504 covers the address bar content of the browser window 502. Note that the bogus address bar content in the popup 504 is slightly offset to highlight what is taking place in this example. In order to perfect the scam, a malicious web page would likely not have this offset or reduce it such that a user might not catch the overlay. One skilled in the art will appreciate that, in this case, the popup 504 appears outside the browser content area, or parent window 506, of the browser window 502, since the content area does not include the address bar.

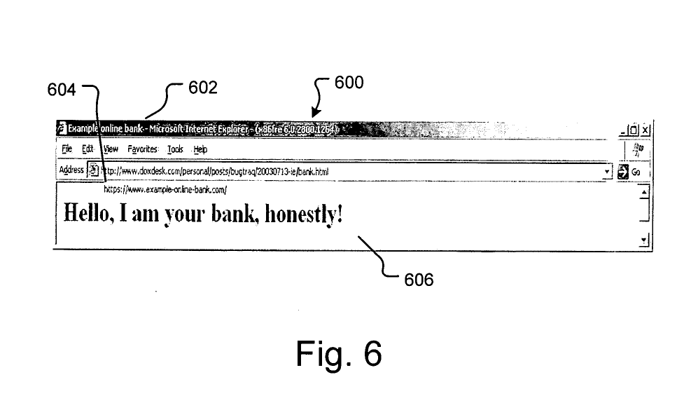

FIG. 6 illustrates an example screenshot 600 where, using an embodiment of the present invention, the misleading popup 604 is subject to the restrictions shown and described above with respect to FIG. 4, and thus is less likely to mislead the user as which site is being viewed. In this case, the proposed popup position extends above the top of the parent window 606, which causes determine operation 410 to branch YES to adjust operation 412. Adjust operation 412 adjusts the proposed popup position downward before it is displayed by display operation 422. In this way, the popup 604 is kept from obscuring the controls of the browser window 602.

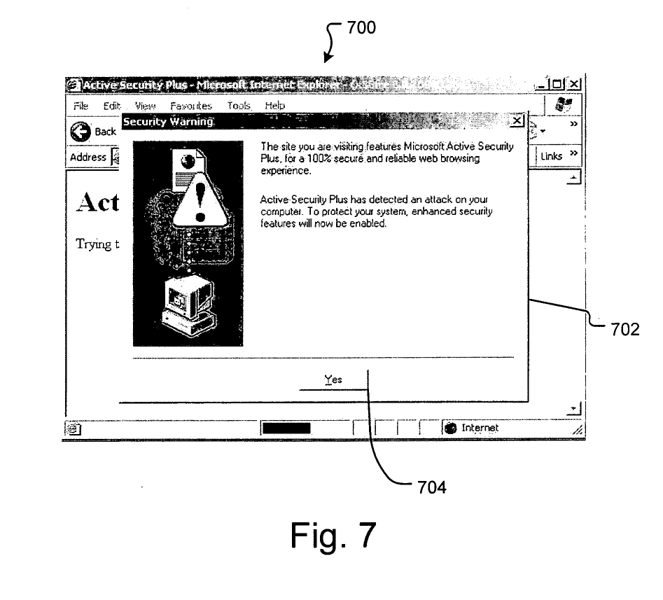

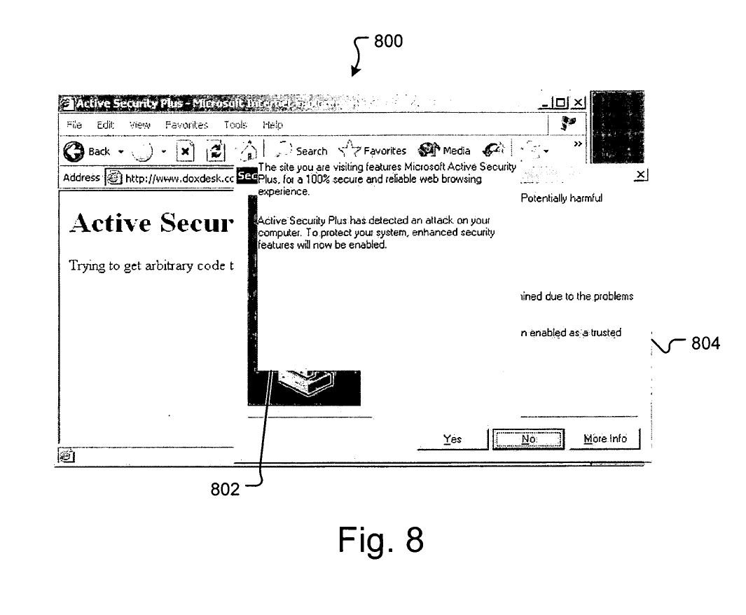

FIG. 7 illustrates another example screenshot 700 where, without the use of the present invention, a popup (see popup 802 on FIG. 8; also pictured on top of a dialog box 702 in FIG. 7) is created which covers portions of the dialog box 702, including the textual content of the dialog (pictured in FIG. 8), and two buttons (also pictured in FIG. 8). Such a page could mislead the user into selecting the “Yes” button 704, which may trigger behavior different than what the unwelcome dialog window suggests.

FIG. 8 illustrates an example screenshot 800 where, using an embodiment of the present invention, the misleading popup 802 is subject to the described restrictions, and thus is less likely to mislead the user as to the contents of the dialog box 804. In this case, the proposed popup position (as illustrated in FIG. 7) extends above the top of the parent window, and also does not appear immediately above the parent window. In this situation, referring back to FIG. 4, determine operation 410 branches YES to adjust operation 412, which adjusts the proposed popup position downward before it is displayed by display operation 422. The intermediate result, if displayed, would appear as depicted in FIG. 8.

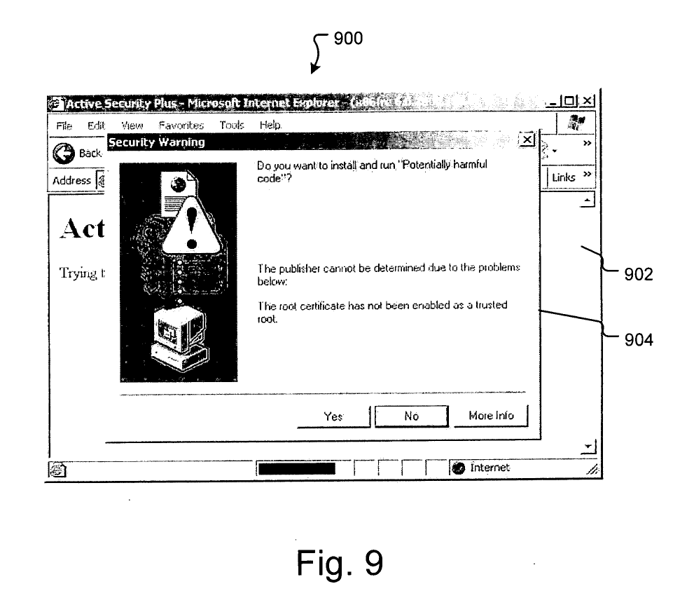

FIG. 9 illustrates a continuation of the example displayed and discussed with respect to FIG. 8. Since the proposed popup (not pictured) still does not appear immediately above the parent window 902, determine operation 418 will branch NO to adjust operation 420. Adjust operation 420 then positions the popup (not pictured) immediately above the parent window 902, which prevents it from obscuring any part of the dialog 904. The popup is still there, but underneath the dialog box. The end result 900 can be seen in FIG. 9. As a result, the user can easily detect the attempted spoof, and is unlikely to be fooled into selecting a potentially harmful response to the dialog box 904.

While the aforementioned exemplary embodiments were presented in the context of a browser application, one skilled in the art will appreciate that the claimed invention could be used in any other context or environment where windows are created by external content, or by a remote client, or any other environment where non-trusted content can create windows, without departing from the scope of the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A computer-implemented method for the preservation of browser window integrity comprising:
receiving a window position;
receiving a window size;
adjusting the window position as necessary to preserve critical data on a screen;
adjusting the window size as necessary to preserve critical data on the screen; and
drawing a window at said adjusted window position with said adjusted window size.

2. A computer-implemented method as defined in claim 1, wherein said adjusting the window size comprises reducing the window size.

3. A computer-implemented method as defined in claim 1, wherein said window is a popup.

4. A computer-implemented method as defined in claim 1, wherein said receiving a window position comprises using a default window position.

5. A computer-implemented method as defined in claim 1, wherein said receiving a window size comprises using a default window size.

6. A computer-implemented method as defined in claim 4, wherein said adjusting the window position step is omitted when said default window position is used.

7. A computer-implemented method as defined in claim 5, wherein said adjusting the window size step is omitted when said default window size is used.

8. A system for the preservation of browser window integrity comprising:
a receiving module for receiving a position and a size of a script-created window;
a position adjustment module for adjusting the position of the script-created window;
a size adjustment module for adjusting the size of the script-created window; and
a display module for displaying the script-created window at said position and said size.

9. A system as defined in claim 8, wherein the size adjustment module reduces the size of the script-created window.

10. A system as defined in claim 8, wherein the script-created window is a popup.

11. A system as defined in claim 8, wherein the script-created window is created by locally hosted content.

12. A system as defined in claim 8, wherein the script-created window is created by remotely hosted content.

13. A method for popup sizing and placement wherein window integrity is preserved comprising:
reducing a popup size to be less than a vertical size of a parent window;
adjusting a popup position so that a popup does not extend above a top of the parent window;
adjusting the popup position so that the popup does not extend below a bottom of the parent window;
adjusting the popup position so that the popup overlaps the parent window by a specified amount; and
adjusting the popup position so that the popup appears immediately above the parent window.

14. A method as defined in claim 13, further comprising receiving position and size data for the popup.

15. A method as defined in claim 13, further comprising using default position and size data for the popup.

16. A method as defined in claim 13, further comprising displaying the popup.

17. A method as defined in claim 13, wherein said reducing a popup size step reduces the popup size to be less than or equal to the vertical size of the parent window.

18. A method as defined in claim 13, further comprising:
forcing the popup to include a status bar.
